(19) United States
(12) Patent Application Publication
(10) Pub. No.: US 2017/0025047 A1
(43) Pub. Date: Jan. 26, 2017

(54) DEVICE FOR SUPPORTING CARD, PAPERS OR PHOTOGRAPHS

(71) Applicants: Luis LÓPEZ TORRUBIA, Madrid (ES); Ángel PONS ARIIÑO MANDATARIO, Madrid (ES)

(72) Inventors: Luis LÓPEZ TORRUBIA, Madrid (ES); Ángel PONS ARIIÑO MANDATARIO, Madrid (ES)

(21) Appl. No.: 15/301,023

(22) PCT Filed: Apr. 1, 2015
(86) PCT No.: PCT/ES2015/070266

§ 371 Date: Sep. 30, 2016

(30) Foreign Application Priority Data
Apr. 1, 2014 (ES) U201430439

(51) Int. Cl. G09F 3/20; B60R 13/10

(52) U.S. Cl. CPC G09F 3/203; B60R 13/105

(57) ABSTRACT

The invention relates to a device for supporting cards, papers or photographs, for joining easily and quickly to a surface (2). The device comprises a sheet-type body (1) with a first portion (3) that comprises adhesive on one of the faces thereof and is to be joined to the surface (2), a second portion (4) extending from the first portion (3), forming a first obtuse angle (5), and a third portion (6) which extends from the second portion (4), forming a second obtuse angle (7), the end of which is designed to come into contact with the surface (2), and at least the second portion (4) and the third portion (6) are transparent.

### OBJECT OF THE INVENTION

The present invention is framed within the technical field of supports for cards, paper or photographs.

More specifically, it is a support device especially designed to be installed comfortably and quickly on a surface on which said card, paper or photograph is desired to be placed. The support device is transparent at least in part of its surface to allow for the complete view of the card, paper or photograph which it supports.

### BACKGROUND OF THE INVENTION

At present in many cities in Spain and other countries, there are certain parking lots for vehicles which are restricted, for example to disabled individuals or for example to individuals who reside in a determined neighborhood.

In said cases, the town halls are responsible for issuing limited parking cards which are non-transferrable and which serve to certify that the users of the vehicles have the right to park in these spaces.

In order to check that a determined vehicle has the right to be parked in these restricted areas, it is necessary for the users to always carry in the vehicle the parking card assigned to them when they meet the requirements. The users thus always have to have these cards in a visible location in the vehicle.

In the majority of cases, the users opt to leave the card supported on the glove compartment of the vehicle, where they usually also insert their tickets with the time which indicate that they have paid the price for a parking space and the time until which this right is valid.

The problem with this solution is that when the vehicle is started because the user has to move using said vehicle, as the card is not secured to anything it moves all over the glove compartment when the vehicle turns. This movement may be distracting to the driver who wants to pick up the card before it moves too much or falls and this could end up causing an accident. Another disadvantage of this is that since the card is moved, it may become lodged in a groove or nook between the glove compartment and the windows of the vehicle, it may even become lost.

Another solution which is known in the state of the art is the use of an adhesive tape for fixing the card to the window of the vehicle. The problem with this system is that it looks aesthetically rather unpleasant and moreover once the card has been fixed to the window it cannot be removed from there. In many cases the users wish to have the option of removing and inserting the cards at the time they wish and they are reluctant to use this home-made solution of adhering it with adhesive tape.

### DESCRIPTION OF THE INVENTION

The present invention proposes a support device for cards, paper or photographs which allows the previously described problems to be solved. It is a support device intended to be joined to a surface on which it is desired to place cards, papers or photographs and has at least one transparent portion in order to be able to view these objects fully.

The configuration of the support device means that when it is joined to the surface on which it is installed the rest of the device adopts a form which allows it to carry out a clamp type securing effect to maintain the cards, papers or photographs secured in the desired position against the surface on which it is installed.

The most obvious application of the device of the present invention is to place it joined to a window of a vehicle, using the interior part thereof to place the resident or disabled parking card in said device. However, the present device may also be used in vehicles for placing the payment slip tickets of regulated parking areas or for other support applications.

In the first example, the card is inserted in the support device and can be left there for the entire time that the user wishes and in the second example the user can insert payment tickets of the regulated parking areas in the device in order to have them ordered and to ensure that they are in a visible location.

Other applications which the support device of the present invention may have are placing photos on walls or on furniture or domestic appliances in order to decorate the house or any other living space.

At the same time, the support device may be used for example to place it on furniture in the house or on a wall to insert notes in it which the tenants of the house wish to leave or it may be used in restaurants to leave business cards or the menus, etc.

A very significant advantage of the support device of the present invention is that it is manufactured in low-cost materials, such as for example plastic and that its manufacture is also cheap since it is preferably manufactured by performing die-cutting operations to cut them to the desired shape and pressing operations to give them the required angles so that the clamp effect is created which allows cards, papers or photographs to be supported.

### DESCRIPTION OF THE DRAWINGS

In order to complement the description being made and with the object of helping to better understand the characteristics of the invention, in accordance with a preferred practical embodiment thereof, said description is accompanied, as an integral part thereof, by a set of drawings where, in an illustrative and non-limiting manner, the following has been represented:

FIG. 1 shows a view of the support device for cards, papers and photographs.

FIG. 2 shows a view of a laminate plate from which two laminate bodies are obtained which form two support devices.

FIG. 3 shows a view of a support device used to secure a resident parking card.

### PREFERRED EMBODIMENT OF THE INVENTION

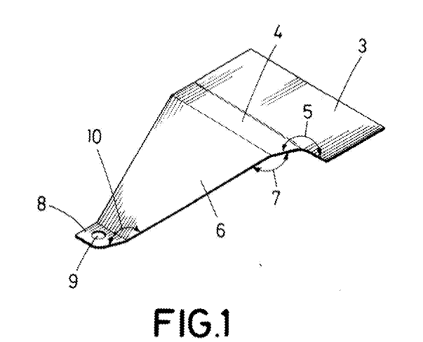

An exemplary embodiment of the invention is presented below with the aid of FIGS. 1 to 3.

As can be seen in FIG. 1, the support device for cards, papers or photographs has a configuration which, when it is installed on a surface by joining it to said surface at one of its ends, the other end performs a clamp effect intended to maintain the desired card, paper or photograph adhered to the wall.

The device comprises a continuous laminate body (1) which comprises a first portion (3) which has adhesive on one of its faces and is intended to be joined to the surface (2). The support device can thus be joined to a wall, to a window, to a metallic surface, to furniture, etc.

At the same time, the device comprises a second portion (4) which extends from the first portion (3) forming a first obtuse angle (5) and a third portion (6) which starts from the second portion (4) forming a second obtuse angle (7) and the end of which is intended to be in contact with the surface (2). That is to say, an obtuse-angled triangle is formed between the second portion (4), the third portion (6) and the surface (2).

The first obtuse angle (5) which is formed between the first portion (3) and the second portion (4) is preferably formed when the device is placed in its position. That is to say, when the device is at rest, there are no angles between the first portion (3) and the second portion (4), but rather they are aligned. The first obtuse angle (5) is formed when the first portion (3) is joined to the surface (2). In this position, the second portion (4) extends, separating from the surface (2) with an inclination of more than 90° with respect to the first portion (3) which is joined to said surface (2). As has been described, in this embodiment the first portion (3) and the second portion (4) are a single extended portion and therefore there is not vertex between them, but rather a curve. The first obtuse angle (5) marks the degrees of inclination of the second portion (4) with respect to the first portion (3).

Owing to the configuration of the device, the end of the third portion (6) intended to be in contact with the surface (2) allows the card, paper or photograph, which is desired to be shown in the support device, to be supported.

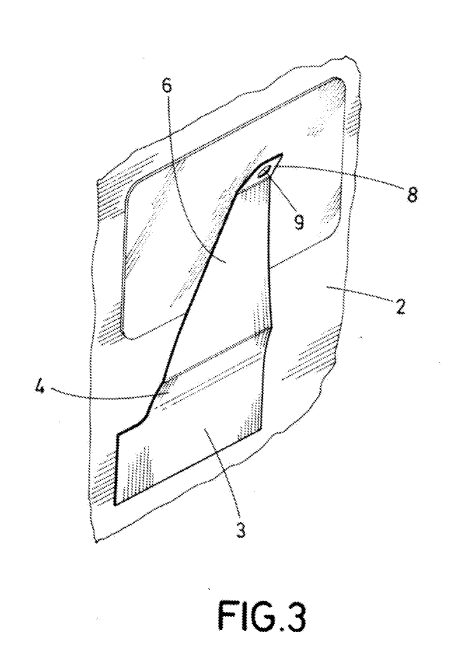

The support device is thus placed on a determined surface (2) joining the first portion (3) to said surface (2). The desired card, paper or photograph are placed, supported on the surface (2) behind the second portion (4) and the third portion (6) and are maintained in said position since the end of the third portion (6) presses them against the surface (2), as is observed in the example of FIG. 3.

At least the second portion (4) and the third portion (6) are transparent so that they do not affect the view of the card, paper or photograph which is inserted in the device.

The first portion (3), as it is intended to be adhered to the surface (2), does not necessarily have to be transparent and therefore the manufacturer may take advantage of this in order to make it in any color or with decorative figures. Promotional material may also be inserted in the device.

In an embodiment of the invention, the laminate body (1) also comprises a fourth portion (8) which starts from the end of the third portion (6) which is intended to be in contact with the surface (2). Said fourth portion (8) preferably forms a third obtuse angle (1) with the third portion (6).

The function of the fourth portion (8) is to allow a more comfortable grip of the laminate body (1) in order to be able to separate it from the surface (2) at the area of the end of the third portion (6) which exerts pressure on the surface (2) in order to be able to comfortably introduce the desired card, paper or photograph. When said fourth portion (8) is released, the end of the third portion (6) returns to its position and presses the card, paper or photograph which has been inserted, thus ensuring its position.

In an exemplary embodiment of the invention, the fourth portion (8) comprises a hole (9). This hole (9) is intended to facilitate the display of the support device in stores since the hole (9) may be used to house the device on a hanger.

In an embodiment of the invention, the support device also comprises a sheet with a geometry identical to that of the laminar body (1) and which is joined to the laminate body (1) at the first portion (3) by means of the adhesive of said first portion (3). The sheet has the same portions as the laminate body (1) and they are joined together at the same angles, consequently it is perfectly adapted to the face of the laminate body intended to be opposed to the surface (2).

It is a sheet which is joined to the laminate body (1) when it is not being used and which may contain promotional material or decorative patterns so that the potential buyer feels more attracted to the product. When it is desired to use the support device, the sheet is removed, detaching it from the first portion (3) of the laminate body (1) and said laminate body (1) is adhered to the desired surface (2) and the desired card, paper or photograph is subsequently inserted.

The laminate body (1) is preferably made of plastic. This material is sufficiently flexible so as to allow the laminate body to be given the previously described geometry and so that the user may separate it from the surface (2) when the cards, papers or photographs are inserted.

In a preferred embodiment, the manufacture of the laminate body of the present invention is carried out, proceeding from a plastic plate on which a die-cutter is applied by means of which each laminate body (1) is cut. The laminate bodies (1) are subsequently introduced into presses by means of which they are folded at the desired points in order to obtain the previously described obtuse angles. With these press strokes, the final desired form is obtained.

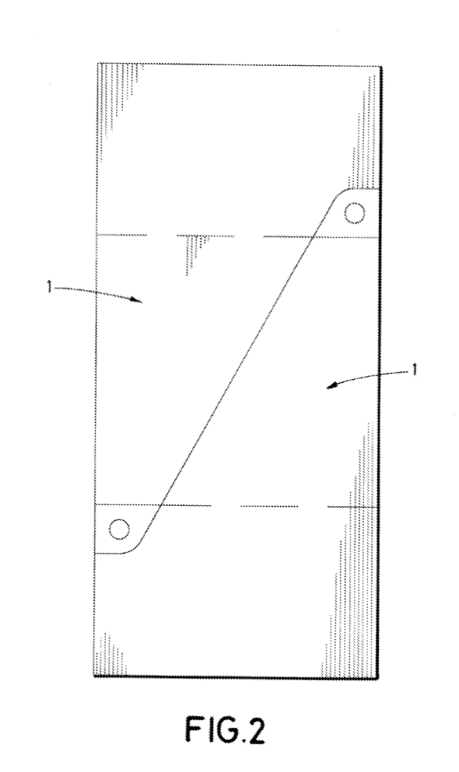

In FIG. 2, an exemplary embodiment of the support device is seen in which the die-cutting lines, by way of which the cuts are produced, have been indicated. In this case, a geometry has been selected which allows two identical devices to be obtained with only one die-cutting in order to take the fullest advantage of the laminate plate from which its configuration proceeds.

In another embodiment of the invention, at least the first portion (3), the second portion (4) or the third portion (6) comprise a plurality of perforations. These perforations may be made in the same die-cutting machine in which the laminate bodies are cut and may have a decorative function.

As has been previously described, the second portion (4) and the third portion (6) (also the fourth portion (8) in the case there is one) must be transparent in order to not interfere with the view of the card, paper or photograph. However, owing to the perforations, which may have any form, such as for example a star form, the support device may be personalized.

1. A support device for cards, papers or photographs intended to be joined to a surface (2) and which is characterized in that it comprises a laminate body (1) having:
a first portion (3) which has adhesive on one of its faces and is intended to be joined to the surface (2),
a second portion (4) which extends from the first portion (3) forming a first obtuse angle (5)
a third portion (6) which starts from the second portion (4) forming a second obtuse angle (7) and the end of which is intended to be in contact with the surface (2),
and at least the second portion (4) and the third portion (6) are transparent.

2. The support device for cards, papers or photographs according to claim 1, characterized in that the laminate body (1) also comprises a fourth portion (8) which starts from the end of the third portion (6) which is intended to be in contact with the surface (2) forming a third obtuse angle (10).

3. The support device for cards, papers or photographs according to claim 2, characterized in that the fourth portion (8) comprises a hole (9).

4. The support device for cards, papers or photographs according to claim 2, characterized in that the fourth portion (8) is transparent.

5. The support device for cards, papers or photographs according to claim 1, characterized in that it also comprises a sheet with a geometry identical to that of the laminar body (1) and which is joined to the said body at the first portion (3) by means of the adhesive of said first portion (3).

6. The support device for cards, papers or photographs according to claim 1, characterized in that the laminate body (1) is made of plastic.

7. The support device for cards, papers or photographs according to claim 1, characterized in that at least the first portion (3), the second portion (4) or the third portion (6) comprise a plurality of perforations.
